(19) United States
(12) Patent Application Publication
(10) Pub. No.: US 2019/0321843 A1
(43) Pub. Date: Oct. 24, 2019

(54) Autonomous Coating Robot

(71) Applicant: The Boeing Company, Chicago, IL (US)

(72) Inventors: Troy Dean Potensky, Issaquah, WA (US); Timothy Ray Kaiser, Marysville, WA (US); Samantha Marie Chapman, Snohomish, WA (US); Emily Anne Ternes, Marysville, WA (US)

(21) Appl. No.: 15/957,797

(22) Filed: Apr. 19, 2018

(51) Int. Cl. B05B 12/00; B05B 15/70

(52) U.S. Cl. CPC B05B 12/004; B05B 15/70

(57) ABSTRACT

A coating is supplied to an autonomous coating robot through an external supply line connected to a coating supply port in a housing of the autonomous coating robot. The coating is sprayed onto a surface of a substrate using a sprayer of the autonomous coating robot as the autonomous coating robot traverses the surface of the substrate such that the coating covers the surface of the substrate, wherein the sprayer is fluidly connected to the coating supply port, and wherein the autonomous coating robot traverses the surface of the substrate using a pair of drive wheels connected to a housing of the autonomous coating robot.

### BACKGROUND INFORMATION

### 1. Field

The present disclosure relates generally to manufacturing and, more specifically, to applying coatings. Yet more specifically, the present disclosure relates to using a robot to autonomously apply a coating.

### 2. Background

In composite manufacturing, uncured composite materials are laid up on composite forming tools, such as mandrels or other large substrates. Prior to laying up a new composite structure, a composite forming tool is cleaned and a release coating is applied.

Currently, cleaning and coating applications are performed by human operators. Cleaning and applying coatings may take an undesirable amount of time. Preparation of large tools may also limit the ability of a human operator to access the entire surface of the tool, therefore requiring support, safety, or fall protection equipment. Cleaning and applying coating also may take an undesirable amount of expertise.

For some release coatings, contact or extended exposure to human operators may be undesirable. For some coatings, human operators may wear chemical resistant gear when handling the coatings.

Therefore, it would be desirable to have a method and apparatus that takes into account at least some of the issues discussed above, as well as other possible issues. For example, it would be desirable to provide at least one of an apparatus or a process for reducing human operator coating application time for a composite forming tool.

### SUMMARY

An illustrative example of the present disclosure provides an autonomous coating robot. The autonomous coating robot comprises a housing, a pair of drive wheels, a plurality of sensors, and a sprayer. The housing has a coating supply port configured to mate with an external supply line. The pair of drive wheels is connected to the housing. The plurality of sensors is associated with the housing. The sprayer is fluidly connected to the coating supply port.

Another illustrative example of the present disclosure provides a method. A coating is supplied to a sprayer of an autonomous coating robot through an external supply line. The coating is sprayed onto a surface of a substrate while driving the autonomous coating robot in a first series of parallel connected paths across the surface of the substrate. The coating is sprayed onto the surface of the substrate while driving the autonomous coating robot in a second series of parallel connected paths across the surface of the substrate, wherein the first series of parallel connected paths is perpendicular to the second series of parallel connected paths.

Yet another illustrative example of the present disclosure provides a method. A coating is supplied to an autonomous coating robot through an external supply line connected to a coating supply port in a housing of the autonomous coating robot. The coating is sprayed onto a surface of a substrate using a sprayer of the autonomous coating robot as the autonomous coating robot traverses the surface of the substrate such that the coating covers the surface of the substrate, wherein the sprayer is fluidly connected to the coating supply port, and wherein the autonomous coating robot traverses the surface of the substrate using a pair of drive wheels connected to a housing of the autonomous coating robot.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of a manufacturing environment in which an autonomous coating robot operates in accordance with an illustrative example;

FIG. 2 is an illustration of an isometric view of a manufacturing environment in which an autonomous coating robot operates in accordance with an illustrative example;

FIG. 3 is an illustration of a top view of an autonomous coating robot moving across a substrate in accordance with an illustrative example;

FIG. 4 is an illustration of an isometric view of an autonomous coating robot in accordance with an illustrative example;

FIG. 5 is an illustration of a top view of an autonomous coating robot in accordance with an illustrative example;

FIG. 6 is an illustration of a bottom view of an autonomous coating robot in accordance with an illustrative example;

FIG. 7 is an illustration of a bottom view of an autonomous coating robot in accordance with an illustrative example;

FIG. 8 is an illustration of a flowchart of a method for operating an autonomous coating robot in accordance with an illustrative example;

FIG. 9 is an illustration of a flowchart of a method for operating an autonomous coating robot in accordance with an illustrative example;

FIG. 10 is an illustration of an aircraft manufacturing and service method in the form of a block diagram in accordance with an illustrative example; and

FIG. 11 is an illustration of an aircraft in the form of a block diagram in which an illustrative example may be implemented.

### DETAILED DESCRIPTION

The illustrative embodiments recognize and take into account one or more different considerations. For example, the illustrative embodiments recognize and take into account that conventional coating applicators in manufacturing are tied to a single location. For example, robotic arms with sprayer end effectors may be tied to a single location floor of a manufacturing environment. The illustrative embodiments recognize and take into account that in automobile manufacturing, a car chassis or other structure is moved in front of the robotic arms. The illustrative embodiments recognize and take into account that the robotic arms have a limited range of motion and a limited spray area.

The illustrative embodiments recognize and take into account that a range for conventional spray arms is insufficient to spray large composite structures. The illustrative embodiments recognize and take into account that it would be desirable to have a robot that can apply a coating to a large composite structure.

The illustrative examples recognize and take into account that it would be desirable to have a robot to apply a release coating prior to laying up a new composite structure on a composite forming tool. The illustrative examples recognize and take into account that it would be desirable for a robot to autonomously apply the release coating to reduce the exposure to human operators. The illustrative examples recognize and take into account that it would be desirable to provide a robot that can access the entire surface of a large tool.

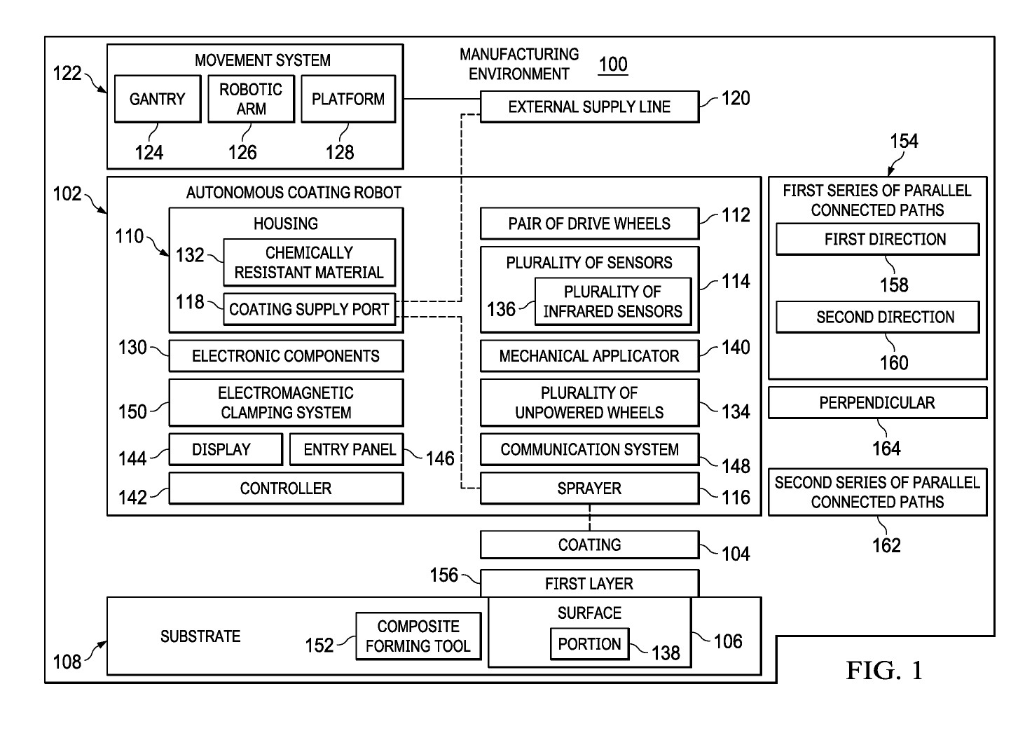

Turning now to FIG. 1, an illustration of a block diagram of a manufacturing environment in which an autonomous coating robot operates is depicted in accordance with an illustrative example. Coating application processes performed in manufacturing environment 100 may be performed by autonomous coating robot 102. Autonomous coating robot 102 is used to apply coating 104 to surface 106 of substrate 108.

Autonomous coating robot 102 comprises housing 110, pair of drive wheels 112, plurality of sensors 114, and sprayer 116. Housing 110 has coating supply port 118 configured to mate with external supply line 120.

External supply line 120 supplies coating 104 to autonomous coating robot 102. In some illustrative examples, coating 104 comprises one of a release coating, a paint, or a maskant. External supply line 120 is a conduit that moves within manufacturing environment 100. As depicted, external supply line 120 is maneuvered within manufacturing environment 100 by movement system 122. Movement system 122 takes any desirable form. Movement system 122 may be at least one of gantry 124, robotic arm 126, or platform 128.

As used herein, the phrase “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

This example also may include item A, item B, and item C, or item B and item C. Of course, any combination of these items may be present. In other examples, “at least one of” may be, for example, without limitation, two of item A, one of item B, and ten of item C; four of item B and seven of item C; or other suitable combinations.

For example, gantry 124 may move in any desirable direction within manufacturing environment 100 to move external supply line 120 based on placement and movement of autonomous coating robot 102 within manufacturing environment 100. In some illustrative examples, gantry 124 accesses any area of manufacturing environment 100.

In some illustrative examples, movement system 122 takes the form of robotic arm 126. When movement system 122 takes the form of robotic arm 126, robotic arm 126 maintains external supply line 120 above substrate 108.

In some illustrative examples, platform 128 includes an extension configured to maintain external supply line 120 above substrate 108. In some illustrative examples, when movement system 122 takes the form of platform 128, external supply line 120 may be stored on a reel on platform 128. In some illustrative examples, when movement system 122 takes the form of platform 128, external supply line 120 may be under tension.

External supply line 120 mates with coating supply port 118 to provide coating 104 to autonomous coating robot 102. Housing 110 is configured to cover and protect electronic components 130 of autonomous coating robot 102 during operation. Housing 110 is formed of any desirable material. In some illustrative examples, housing 110 is formed of chemically resistant material 132 configured to protect electronic components 130 of autonomous coating robot 102 from coating 104. In some illustrative examples, chemically resistant material 132 is selected based on the type of material of coating 104.

Pair of drive wheels 112 is connected to housing 110. As used herein, a first component “connected to” a second component means that the first component can be connected directly or indirectly to the second component. In other words, additional components may be present between the first component and the second component. The first component is considered to be indirectly connected to the second component when one or more additional components are present between the two components. When the first component is directly connected to the second component, no additional components are present between the two components.

Pair of drive wheels 112 is used to move autonomous coating robot 102 across substrate 108. Force applied using pair of drive wheels 112 propels autonomous coating robot 102.

In some illustrative examples, autonomous coating robot 102 also comprises plurality of unpowered wheels 134. When plurality of unpowered wheels 134 is present, plurality of unpowered wheels 134 provides balance to autonomous coating robot 102 as autonomous coating robot 102 traverses substrate 108.

Plurality of unpowered wheels 134 takes any desirable form. Plurality of unpowered wheels 134 may be selected from casters, captured ball wheels, or any other desirable type of unpowered wheels.

Plurality of sensors 114 is associated with housing 110. When one component is “associated” with another component, the association is a physical association in the depicted examples. For example, a first component may be considered to be associated with a second component by being secured to the second component, bonded to the second component, mounted to the second component, welded to the second component, fastened to the second component, and/or connected to the second component in some other suitable manner. The first component also may be connected to the second component using a third component. The first component may also be considered to be associated with the second component by being formed as part of and/or an extension of the second component.

Plurality of sensors 114 includes any desirable type of sensors. In some illustrative examples, plurality of sensors 114 includes only one type of sensor. In some illustrative examples, plurality of sensors 114 includes more than one type of sensor.

In some illustrative examples, plurality of sensors 114 includes at least one of a level sensor, a proximity sensor, an ultrasonic sensor, or any other desirable type of sensor. In some illustrative examples, plurality of sensors 114 includes at least one proximity sensor in the form of an infrared sensor. In some illustrative examples, plurality of sensors 114 comprises plurality of infrared sensors 136.

In some illustrative examples, plurality of sensors 114 is configured to detect edges of substrate 108. In some illustrative examples, by detecting edges of substrate 108, plurality of sensors 114 stop autonomous coating robot 102 from undesirably driving off of substrate 108.

In some illustrative examples, when plurality of sensors 114 comprises plurality of infrared sensors 136, substrate 108 is formed of a metal or metal alloy. When plurality of sensors 114 comprises plurality of infrared sensors 136, the metal or metal alloy of substrate 108 will reflect light from plurality of infrared sensors 136.

Sprayer 116 is fluidly connected to coating supply port 118. Sprayer 116 is configured to apply coating 104 to substrate 108. Sprayer 116 is connected to housing 110 in any desirable orientation. In some illustrative examples, sprayer 116 is configured to disperse coating 104 onto portion 138 of substrate 108 beneath housing 110. In some illustrative examples, when sprayer 116 is configured to disperse coating 104 onto portion 138 of substrate 108 beneath housing 110, sprayer 116 also disperses coating 104 to areas of substrate 108 outside of portion 138. For example, when sprayer 116 is configured to disperse coating 104 onto portion 138 of substrate 108 beneath housing 110, sprayer 116 may also disperse coating 104 outside of the footprint of housing 110. In these illustrative examples, sprayer 116 may be connected to a bottom of housing 110. In these illustrative examples, sprayer 116 is connected to housing 110 aft of pair of drive wheels 112.

In some illustrative examples, sprayer 116 is configured to disperse coating 104 onto portion 138 of substrate 108 after housing 110 has passed over portion 138 of substrate 108. In some of these illustrative examples, sprayer 116 is connected to a perimeter of housing 110. In some of these illustrative examples, sprayer 116 is connected to the bottom of housing 110 aft of pair of drive wheels 112.

In some illustrative examples, autonomous coating robot 102 also has mechanical applicator 140. Mechanical applicator 140 may be a brush, a squeegee, or any other desirable mechanical applicator for spreading coating 104 onto surface 106 of substrate 108. In some illustrative examples, mechanical applicator 140 is used to evenly disperse coating 104 onto substrate 108. In some illustrative examples, mechanical applicator 140 is optional.

Controller 142 controls operation and movement of autonomous coating robot 102. In some illustrative examples, controller 142 directs autonomous coating robot 102 based on a known geometry of substrate 108. In other illustrative examples, controller 142 directs autonomous coating robot 102 based on a set of movement rules for autonomous coating robot 102.

As depicted, autonomous coating robot 102 has display 144 and entry panel 146. An operator may interact with autonomous coating robot 102 using at least one of display 144 and entry panel 146.

In some illustrative examples, autonomous coating robot 102 is placed onto substrate 108 by an operator. Afterwards, the operator may initiate application of coating 104 by autonomous coating robot 102 using display 144 and entry panel 146.

In some illustrative examples, autonomous coating robot 102 is equipped with communication system 148. Communication system 148 is configured to enable autonomous coating robot 102 to communicate with a computer system through at least one of wired or wireless communication.

In some illustrative examples, autonomous coating robot 102 is placed onto substrate 108 by movement system 122. In some of these illustrative examples, autonomous coating robot 102 is activated using commands received by communication system 148.

When substrate 108 is substantially planar, gravity maintains autonomous coating robot 102 on surface 106 of substrate 108 as autonomous coating robot 102 traverses substrate 108. When substrate 108 has a complex curvature, additional retention mechanisms may be used. In some illustrative examples, autonomous coating robot 102 further comprises electromagnetic clamping system 150. Electromagnetic clamping system 150 is configured to clamp autonomous coating robot 102 to substrate 108 when substrate 108 is a metal or metal alloy.

In some illustrative examples, when electromagnetic clamping system 150 is present in autonomous coating robot 102, each of plurality of unpowered wheels 134 has an associated shock absorber or other suspension system. In some illustrative examples, when electromagnetic clamping system 150 is present in autonomous coating robot 102, each of pair of drive wheels 112 has an associated shock absorber or other suspension system. When electromagnetic clamping system 150 is engaged, autonomous coating robot 102 remains on surface 106 of substrate 108 as autonomous coating robot 102 traverses surface 106 with a curvature.

In some illustrative examples, substrate 108 takes the form of composite forming tool 152. Composite forming tool 152 is formed of any desirable material. In some illustrative examples, composite forming tool 152 is formed of a material not reactive to composite materials. Composite forming tool 152 has a shape configured to receive composite materials during a composite material application process. In these illustrative examples, coating 104 takes the form of a release film.

Pair of drive wheels 112 and plurality of unpowered wheels 134 contact substrate 108. When substrate 108 takes the form of composite forming tool 152, pair of drive wheels 112 and plurality of unpowered wheels 134 are formed of materials approved for contact with substrate 108.

Autonomous coating robot 102 traverses any desirable path to apply coating 104 to composite forming tool 152. In some illustrative examples, autonomous coating robot 102 traverses substrate 108 multiple times to apply multiple layers of coating 104.

In one illustrative example, autonomous coating robot 102 sprays coating 104 onto surface 106 of substrate 108 while autonomous coating robot 102 drives in first series of parallel connected paths 154 across surface 106 of substrate 108, forming first layer 156 of coating 104 on surface 106. In this illustrative example, first series of parallel connected paths 154 comprises at least one path in first direction 158 and at least one path in second direction 160 connected by a series of connections.

In some illustrative examples, autonomous coating robot 102 is driven across first layer 156 of coating 104 on surface 106 of substrate 108 while driving autonomous coating robot 102 in second series of parallel connected paths 162. In these illustrative examples, second series of parallel connected paths 162 is at an angle to first series of parallel connected paths 154. In some illustrative examples, second series of parallel connected paths 162 is perpendicular 164 to first series of parallel connected paths 154. By traversing substrate 108 using different paths, autonomous coating robot 102 applies multiple layers of coating 104.

The illustration of manufacturing environment 100 in FIG. 1 is not meant to imply physical or architectural limitations to the manner in which an illustrative example may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative example.

For example, although not depicted, autonomous coating robot 102 is powered through any desirable means. In some illustrative examples, although not depicted, autonomous coating robot 102 operates using batteries within autonomous coating robot 102. In other illustrative examples, although not depicted, autonomous coating robot 102 receives power from an external power line also held by movement system 122. For example, an external power line may be part of an umbilical line to autonomous coating robot 102 that includes external supply line 120. In some illustrative examples, autonomous coating robot 102 has a power port in housing 110 to interface with an external power line.

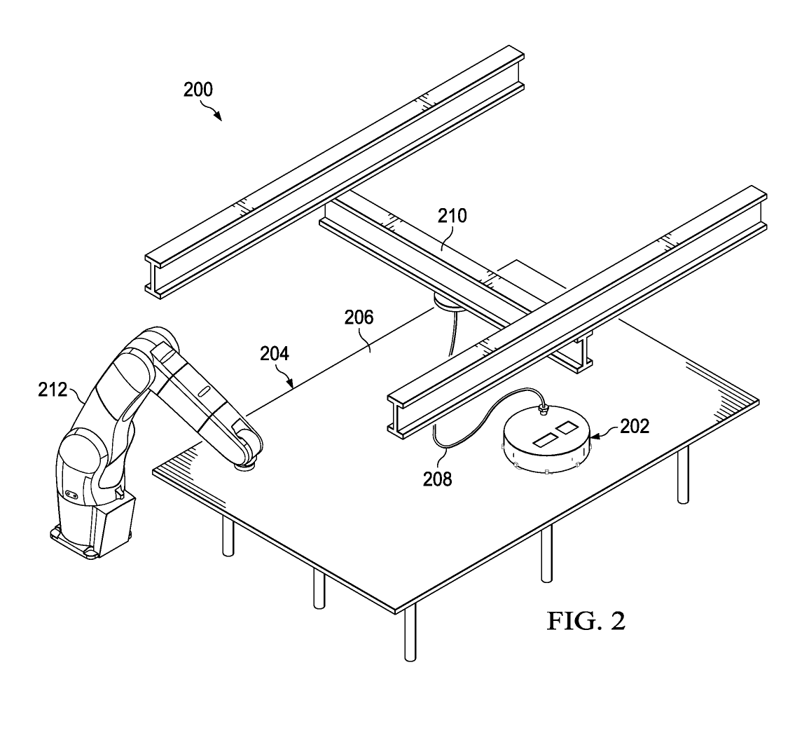

Turning now to FIG. 2, an illustration of an isometric view of a manufacturing environment in which an autonomous coating robot operates is depicted in accordance with an illustrative example. Manufacturing environment 200 is a physical implementation of manufacturing environment 100 of FIG. 1.

As depicted, autonomous coating robot 202 is placed onto substrate 204 within manufacturing environment 200. Autonomous coating robot 202 moves across surface 206 of substrate 204 to apply a coating to surface 206 of substrate 204.

The coating is supplied to autonomous coating robot 202 through external supply line 208. As depicted, external supply line 208 is held by gantry system 210 to keep external supply line 208 from undesirably contacting surface 206. Gantry system 210 is a physical implementation of movement system 122 that moves within manufacturing environment 200. In some illustrative examples, external supply line 208 may be referred to as an umbilical line. In some illustrative examples, external supply line 208 is held by a different movement system, such as robotic arm 212.

In some illustrative examples, autonomous coating robot 202 operates using batteries within autonomous coating robot 202. In other illustrative examples, autonomous coating robot 202 receives power from an external power line also held by gantry system 210. In these illustrative examples, autonomous coating robot 202 may have a power port to interface with the external power line.

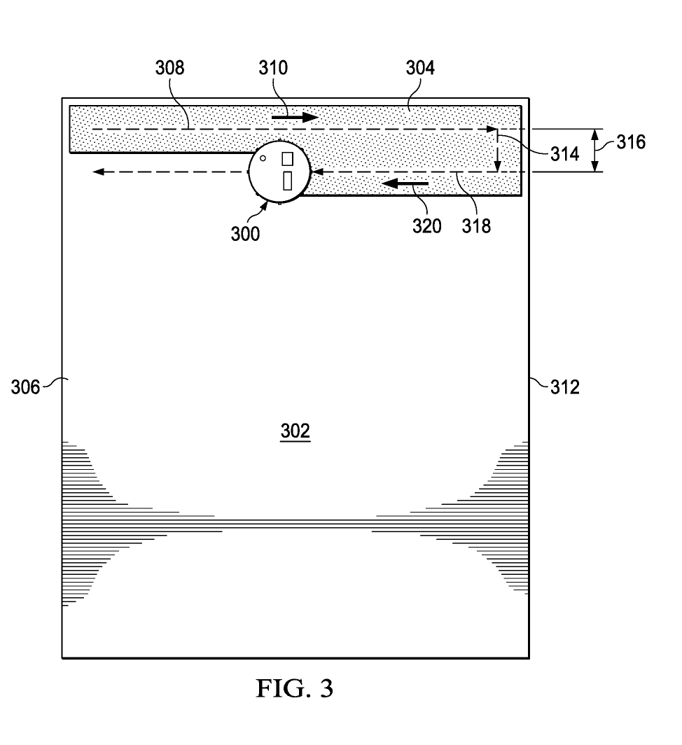

Turning now to FIG. 3, an illustration of a top view of an autonomous coating robot moving across a substrate is depicted in accordance with an illustrative example. As depicted, autonomous coating robot 300 traverses substrate 302 to apply coating 304 to surface 306 of substrate 302. Autonomous coating robot 300 is a physical implementation of autonomous coating robot 102 of FIG. 1.

As depicted, autonomous coating robot 300 is moving in a first series of parallel connected paths across surface 306 of substrate 302. As depicted autonomous coating robot 300 has traversed path 308 in direction 310 while applying coating 304. After sensing edge 312 of substrate 302, autonomous coating robot 300 turns 90 degrees and sprays coating 304 while traveling along connection 314. In some illustrative examples, autonomous coating robot 300 stops spraying coating 304 in response to detecting edge 312 and moves in reverse prior to turning 90 degrees.

Connection 314 has length 316. Length 316 is selected based on a width of spray from autonomous coating robot 300. Length 316 is selected such that autonomous coating robot 300 covers substantially all of surface 306 with coating 304. Length 316 is selected to prevent gaps in coverage of coating 304. In some illustrative examples, length 316 is selected such that some portions of surface 306 have overlapping portions of coating 304.

As depicted, autonomous coating robot 300 is traveling along path 318 in direction 320. Direction 320 and direction 310 are 180 degrees from each other. Path 308 and path 318 are parallel to each other. Connection 314 connects path 308 and path 318. As depicted, autonomous coating robot 300 is traveling across surface 306 in a serpentine fashion.

By continuing to apply coating 304 to surface 306 as autonomous coating robot 300 traverses surface 306, autonomous coating robot 300 applies a first layer of coating to surface 306. In some illustrative examples, it is desirable to apply multiple layers of coating to substrate 302. In some illustrative examples, after applying coating 304 to surface 306 by moving in a first series of parallel connected paths including path 308 and path 318, autonomous coating robot 300 applies a second layer of coating onto the first layer of coating. In some illustrative examples, after applying coating 304 to surface 306 by moving in a first series of parallel connected paths including path 308 and path 318, autonomous coating robot 300 sprays coating 304 while driving autonomous coating robot 300 in a second series of parallel connected paths across the surface of the substrate. In some illustrative examples, the second series of parallel connected paths are perpendicular to the first series of parallel connected paths.

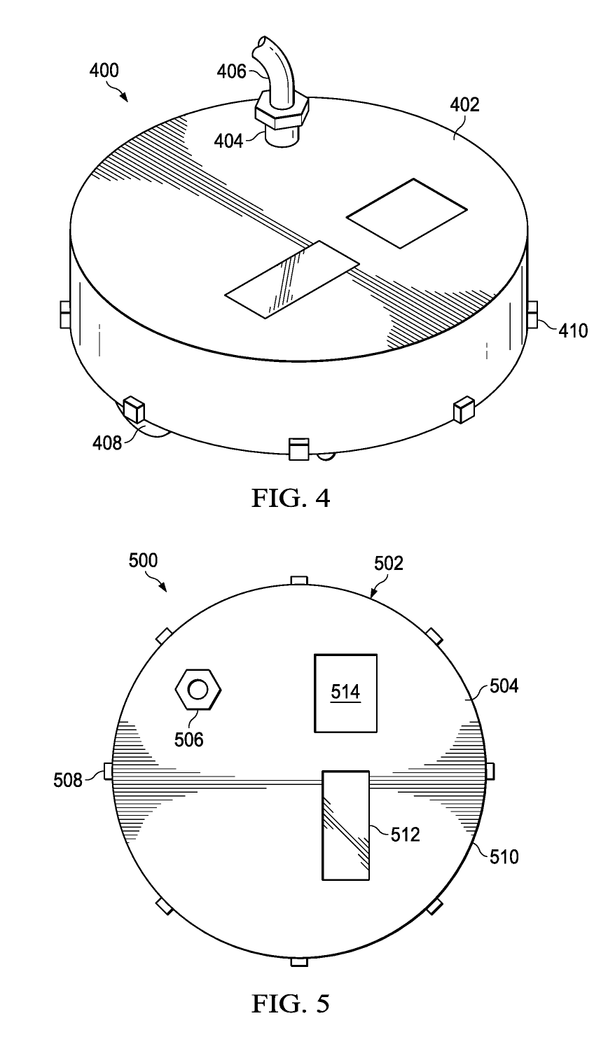

Turning now to FIG. 4, an illustration of an isometric view of an autonomous coating robot is depicted in accordance with an illustrative example. Autonomous coating robot 400 is a physical implementation of autonomous coating robot 102 of FIG. 1. In some illustrative examples, autonomous coating robot 400 may be the same as autonomous coating robot 202 moving across substrate 204 in FIG. 2. In some illustrative examples, autonomous coating robot 400 may be the same as autonomous coating robot 300 of FIG. 3.

Autonomous coating robot 400 comprises housing 402 with coating supply port 404 configured to mate with external supply line 406, pair of drive wheels 408, plurality of sensors 410, and a sprayer (not depicted).

Pair of drive wheels 408 are connected to housing 402. As depicted, plurality of sensors 410 is connected to housing 402. As depicted, plurality of sensors 410 is physically connected to a perimeter of housing 402. Plurality of sensors 410 takes any desirable form. In some illustrative examples, at least one of plurality of sensors 410 is an infrared sensor.

Turning now to FIG. 5, an illustration of a top view of an autonomous coating robot is depicted in accordance with an illustrative example. View 500 is a top view of autonomous coating robot 502. Autonomous coating robot 502 is a physical implementation of autonomous coating robot 102 of FIG. 1. In some illustrative examples, autonomous coating robot 502 may be the same as autonomous coating robot 202 moving across substrate 204 in FIG. 2. In some illustrative examples, autonomous coating robot 502 may be the same as autonomous coating robot 300 of FIG. 3. In some illustrative examples, autonomous coating robot 502 is the same as autonomous coating robot 400 of FIG. 4.

As depicted, autonomous coating robot 502 has housing 504 with coating supply port 506. Coating supply port 506 is configured to mate with an external supply line, such as external supply line 120 of FIG. 1.

Plurality of sensors 508 is associated with housing 504. Plurality of sensors 508 is configured to detect an edge of a substrate as autonomous coating robot travels across the substrate. As depicted, plurality of sensors 508 is physically connected to perimeter 510 of housing 504. Plurality of sensors 508 takes any desirable form. In some illustrative examples, at least one of plurality of sensors 508 is an infrared sensor.

As depicted, display 512 and entry panel 514 are present in housing 504. Display 512 takes any desirable form of display such as LED, LCD, or any other form of display. An operator may interact with autonomous coating robot 502 using display 512 and entry panel 514.

FIG. 5 is not meant to imply physical or architectural limitations to the manner in which an illustrative example may be implemented. For example, in some non-depicted illustrative examples, one or more of display 512 or entry panel 514 is not present. For example, display 512 may be a touch display and entry panel 514 may be optional. In another illustrative example, neither display 512 nor entry panel 514 is present and an operator communicates with autonomous coating robot using wired or wireless communication systems.

As another example, autonomous coating robot 502 may have a power port configured to receive power from a power supply cable. In some examples, a power supply cable and external supply line are physically connected to form an umbilical line to autonomous coating robot 502.

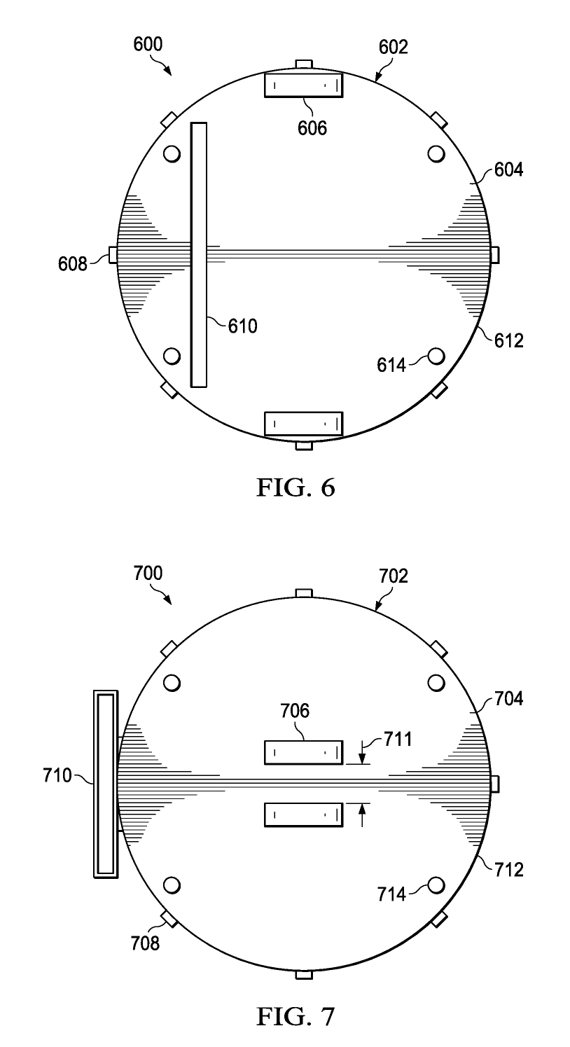

Turning now to FIG. 6, an illustration of a bottom view of an autonomous coating robot is depicted in accordance with an illustrative example. View 600 is a bottom view of autonomous coating robot 602. Autonomous coating robot 602 is a physical implementation of autonomous coating robot 102 of FIG. 1. In some illustrative examples, autonomous coating robot 602 may be the same as autonomous coating robot 202 moving across substrate 204 in FIG. 2. In some illustrative examples, autonomous coating robot 602 may be the same as autonomous coating robot 300 of FIG. 3. In some illustrative examples, autonomous coating robot 602 is the same as autonomous coating robot 400 of FIG. 4. In some illustrative examples, view 600 is a bottom view of autonomous coating robot 502 of FIG. 5.

Autonomous coating robot 602 has housing 604, pair of drive wheels 606, plurality of sensors 608, and sprayer 610. Pair of drive wheels 606 propels autonomous coating robot across a substrate. As depicted, pair of drive wheels 606 is positioned near perimeter 612 of housing 604.

Plurality of unpowered wheels 614 provides balance and stability to autonomous coating robot 602 as autonomous coating robot 602 moves across a substrate. In some illustrative examples, each of plurality of unpowered wheels 614 has an associated shock absorber or other suspension system.

Sprayer 610 is configured to apply a coating to a substrate. Sprayer 610 receives the coating from an external supply line connected to coating supply port 506 of FIG. 5. Sprayer 610 has any desirable size, shape, or placement. As depicted, sprayer 610 is positioned aft of pair of drive wheels 606. By sprayer 610 being positioned aft of pair of drive wheels 606, pair of drive wheels 606 will not track through any uncured coating.

By sprayer 610 being positioned aft of pair of drive wheels 606, sprayer 610 is configured to disperse a coating onto a portion of a substrate one of beneath the housing or after the housing has passed over the portion of the substrate.

Turning now to FIG. 7, an illustration of a bottom view of an autonomous coating robot is depicted in accordance with an illustrative example. View 700 is a bottom view of autonomous coating robot 702. Autonomous coating robot 702 is a physical implementation of autonomous coating robot 102 of FIG. 1. In some illustrative examples, autonomous coating robot 702 may be the same as autonomous coating robot 202 moving across substrate 204 in FIG. 2. In some illustrative examples, autonomous coating robot 702 may be the same as autonomous coating robot 300 of FIG. 3. In some illustrative examples, autonomous coating robot 702 is the same as autonomous coating robot 400 of FIG. 4. In some illustrative examples, view 700 is a bottom view of autonomous coating robot 502 of FIG. 5.

Autonomous coating robot 702 has housing 704, pair of drive wheels 706, plurality of sensors 708, and sprayer 710. Pair of drive wheels 706 propels autonomous coating robot across a substrate. As depicted, spacing 711 between pair of drive wheels 706 is less than the spacing between pair of drive wheels 606 in FIG. 6. With spacing 711, autonomous coating robot 702 may have a smaller turning radius than autonomous coating robot 602.

Plurality of unpowered wheels 714 provide balance and stability to autonomous coating robot 702 as autonomous coating robot 702 moves across a substrate. In some illustrative examples, each of plurality of unpowered wheels 714 has an associated shock absorber or other suspension system.

Sprayer 710 is configured to apply a coating to a substrate. Sprayer 710 receives the coating from an external supply line connected to coating supply port 506 of FIG. 5. Sprayer 710 has any desirable size, shape, or placement. As depicted, sprayer 710 is positioned aft of pair of drive wheels 706 and on perimeter 712. By sprayer 710 being positioned aft of pair of drive wheels 706, pair of drive wheels 706 will not track through any uncured coating. By sprayer 710 being positioned on perimeter 712, sprayer 710 is configured to disperse a coating onto a portion of a substrate after the housing has passed over the portion of the substrate.

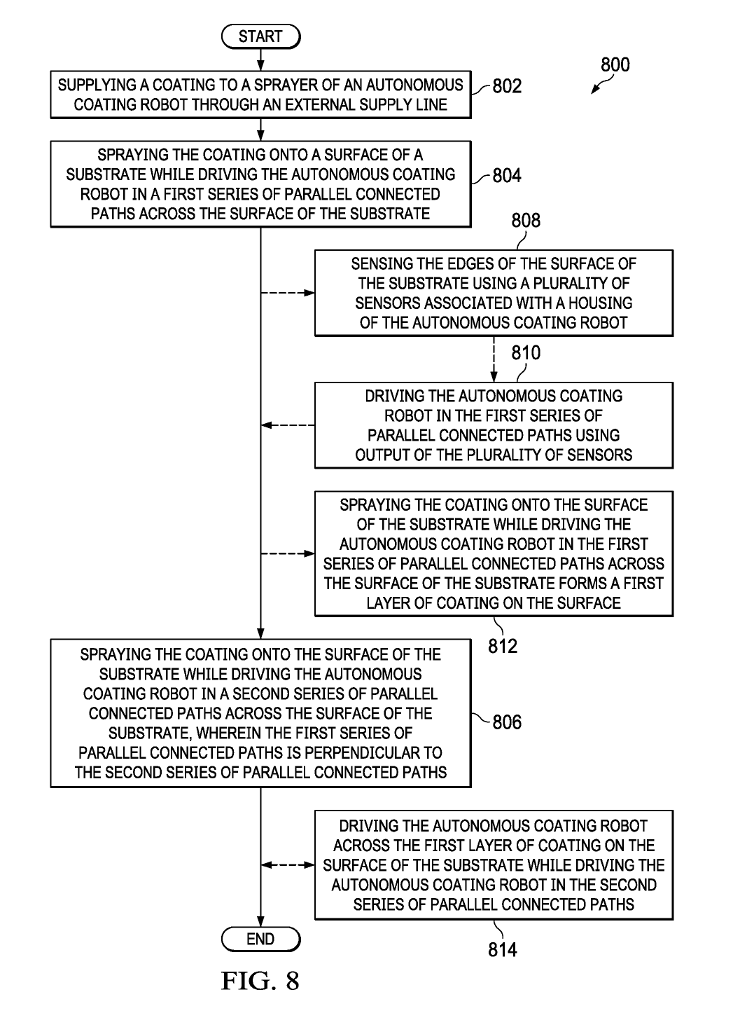

Turning now to FIG. 8, an illustration of a flowchart of a method for operating an autonomous coating robot is depicted in accordance with an illustrative example. Method 800 may be used to operate autonomous coating robot 102 of FIG. 1. Method 800 may be a method of operating autonomous coating robot 202 within manufacturing environment 200. Method 800 may be used to apply coating 304 to substrate 302 using autonomous coating robot 300. Method 800 may be used to operate autonomous coating robot 400 of FIG. 4, autonomous coating robot 502, of FIG. 5, autonomous coating robot 602 of FIG. 6, or autonomous coating robot 702 of FIG. 7.

Method 800 supplies a coating to a sprayer of an autonomous coating robot through an external supply line (operation 802). Method 800 sprays the coating onto a surface of a substrate while driving the autonomous coating robot in a first series of parallel connected paths across the surface of the substrate (operation 804). Method 800 sprays the coating onto the surface of the substrate while driving the autonomous coating robot in a second series of parallel connected paths across the surface of the substrate, wherein the first series of parallel connected paths is perpendicular to the second series of parallel connected paths (operation 806). Afterwards, method 800 terminates.

In some illustrative examples, a length of the connection is selected based on a width of plume of the sprayer. In some illustrative examples, the coating comprises one of a release coating, a paint, or a maskant. In some illustrative examples, the substrate is a composite forming tool.

In some illustrative examples, method 800 senses edges of the surface of the substrate using a plurality of sensors associated with a housing of the autonomous coating robot (operation 808). In some illustrative examples, method 800 drives the autonomous coating robot in the first series of parallel connected paths using output of the plurality of sensors (operation 810).

In some illustrative examples, spraying the coating onto the surface of the substrate while driving the autonomous coating robot in the first series of parallel connected paths across the surface of the substrate forms a first layer of coating on the surface (operation 812). In some illustrative examples, method 800 drives the autonomous coating robot across the first layer of coating on the surface of the substrate while driving the autonomous coating robot in the second series of parallel connected paths (operation 814).

In some illustrative examples, driving the autonomous coating robot in the first series of parallel connected paths comprises driving the autonomous coating robot in a first direction. In some illustrative examples, method 800 further comprises spraying the coating onto the surface of the substrate while driving the autonomous coating robot in the first direction.

In some illustrative examples, method 800 further comprises detecting an edge of the surface of the substrate. In some illustrative examples, method 800 further comprises stopping driving and spraying by the autonomous coating robot. In some illustrative examples, method 800 further comprises driving the autonomous coating robot in reverse. In some illustrative examples in which the autonomous coating robot is driven in reverse, the autonomous coating robot may be delayed for a set period of time until the coating dries so that the coating is not disturbed by the autonomous coating robot. In some illustrative examples in which autonomous coating robot is driven in reverse, the autonomous coating robot may be driven backwards a set distance until reaching the coating. In some illustrative examples, method 800 further comprises turning the autonomous coating robot 90 degrees on the surface of the substrate.

In some illustrative examples, method 800 further comprises spraying the coating onto the surface of the substrate while driving the autonomous coating robot along a connection. In some illustrative examples, method 800 further comprises stopping driving and spraying by the autonomous coating robot.

In some illustrative examples, method 800 further comprises turning the autonomous coating robot 90 degrees on the surface of the substrate. In some illustrative examples, method 800 further comprises driving the autonomous coating robot in a second direction, wherein the first direction is 180 degrees from the second direction. In some illustrative examples, method 800 further comprises spraying the coating onto the surface of the substrate while driving the autonomous coating robot in the second direction.

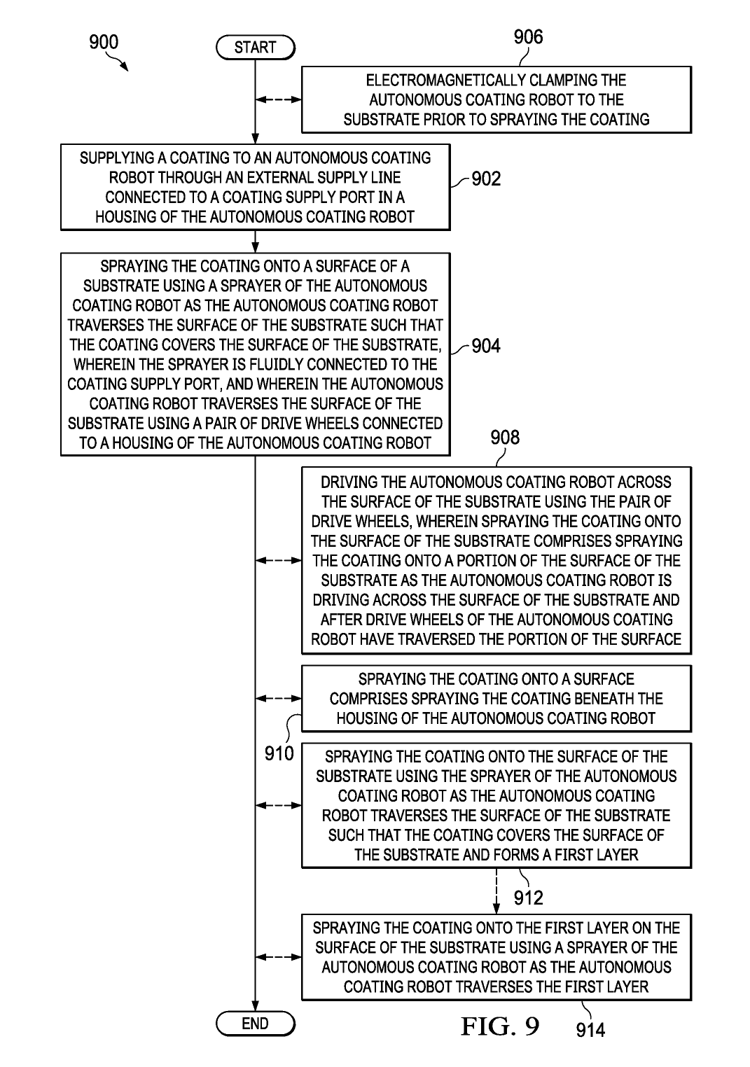

Turning now to FIG. 9 is an illustration of a flowchart of a method for operating an autonomous coating robot is depicted in accordance with an illustrative example. Method 900 may be used to operate autonomous coating robot 102 of FIG. 1. Method 900 may be a method of operating autonomous coating robot 202 within manufacturing environment 200. Method 900 may be used to apply coating 304 to substrate 302 using autonomous coating robot 300. Method 900 may be used to operate autonomous coating robot 400 of FIG. 4, autonomous coating robot 502, of FIG. 5, autonomous coating robot 602 of FIG. 6, or autonomous coating robot 702 of FIG. 7.

Method 900 supplies a coating to an autonomous coating robot through an external supply line connected to a coating supply port in a housing of the autonomous coating robot (operation 902). Method 900 sprays the coating onto a surface of a substrate using a sprayer of the autonomous coating robot as the autonomous coating robot traverses the surface of the substrate such that the coating covers the surface of the substrate, wherein the sprayer is fluidly connected to the coating supply port, and wherein the autonomous coating robot traverses the surface of the substrate using a pair of drive wheels connected to a housing of the autonomous coating robot (operation 904). Afterwards, method 900 terminates.

In some illustrative examples, method 900 electromagnetically clamps the autonomous coating robot to the substrate prior to spraying the coating (operation 906). In some illustrative examples, electromagnetic clamping is performed when the substrate has a curvature. When used, electromagnetic clamping allows the autonomous coating robot to traverse non-planar surfaces.

In some illustrative examples, method 900 also drives the autonomous coating robot across the surface of the substrate using the pair of drive wheels, wherein spraying the coating onto the surface of the substrate comprises spraying the coating onto a portion of the surface of the substrate as the autonomous coating robot is driving across the surface of the substrate and after drive wheels of the autonomous coating robot have traversed the portion of the surface (operation 908). In some illustrative examples, spraying the coating onto a surface comprises spraying the coating beneath the housing of the autonomous coating robot (operation 910). In some illustrative examples in which the coating is sprayed beneath the housing of the autonomous coating robot, the coating may also be sprayed outside of the footprint of the autonomous coating robot.

In some illustrative examples, spraying the coating onto the surface of the substrate using the sprayer of the autonomous coating robot as the autonomous coating robot traverses the surface of the substrate such that the coating covers the surface of the substrate forms a first layer (operation 912). In some illustrative examples, method 900 sprays the coating onto the first layer on the surface of the substrate using a sprayer of the autonomous coating robot as the autonomous coating robot traverses the first layer (operation 914).

The flowcharts and block diagrams in the different depicted examples illustrate the architecture, functionality, and operation of some possible implementations of apparatus and methods in an illustrative example. In this regard, each block in the flowcharts or block diagrams may represent a module, a segment, a function, and/or a portion of an operation or step.

In some alternative implementations of an illustrative example, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added, in addition to the illustrated blocks, in a flowchart or block diagram.

In some illustrative examples, not all blocks of method 800 or method 900 are performed. For example, operations 808 through 814 of FIG. 8 may be optional. As another example, operations 906 through 914 of FIG. 9 may be optional.

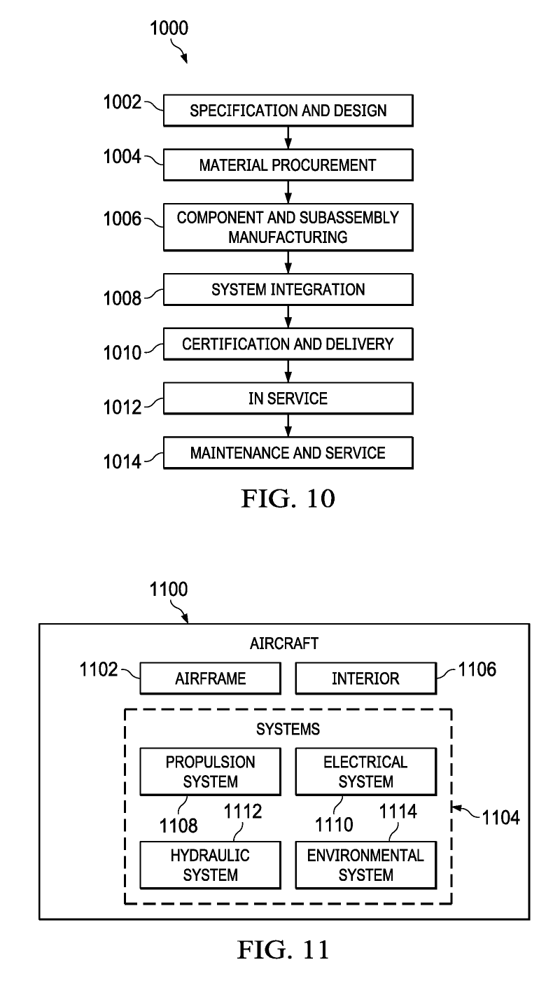

The illustrative examples of the present disclosure may be described in the context of aircraft manufacturing and service method 1000 as shown in FIG. 10 and aircraft 1100 as shown in FIG. 11. Turning first to FIG. 10, an illustration of an aircraft manufacturing and service method is depicted in accordance with an illustrative example. During pre-production, aircraft manufacturing and service method 1000 may include specification and design 1002 of aircraft 1100 in FIG. 11 and material procurement 1004.

During production, component and subassembly manufacturing 1006 and system integration 1008 of aircraft 1100 takes place. Thereafter, aircraft 1100 may go through certification and delivery 1010 in order to be placed in service 1012. While in service 1012 by a customer, aircraft 1100 is scheduled for maintenance and service 1014, which may include modification, reconfiguration, refurbishment, and other maintenance or service.

Each of the processes of aircraft manufacturing and service method 1000 may be performed or carried out by a system integrator, a third party, and/or an operator. In these examples, the operator may be a customer. For the purposes of this description, a system integrator may include, without limitation, any number of aircraft manufacturers or major-system subcontractors; a third party may include, without limitation, any number of vendors, subcontractors, or suppliers; and an operator may be an airline, a leasing company, a military entity, a service organization, and so on.

With reference now to FIG. 11, an illustration of an aircraft is depicted in which an illustrative example may be implemented. In this example, aircraft 1100 is produced by aircraft manufacturing and service method 1000 in FIG. 10 and may include airframe 1102 with a plurality of systems 1104 and interior 1106. Examples of systems 1104 include one or more of propulsion system 1108, electrical system 1110, hydraulic system 1112, and environmental system 1114. Any number of other systems may be included. Although an aerospace example is shown, different illustrative examples may be applied to other industries, such as the automotive industry.

Apparatuses and methods embodied herein may be employed during at least one of the stages of aircraft manufacturing and service method 1000. One or more illustrative examples may be used during component and subassembly manufacturing 1006, system integration 1008, or maintenance and service 1014 of FIG. 10. For example, to form a component of aircraft 1100, autonomous coating robot 102 applies coating 104 to substrate 108 in the form of composite forming tool 152 during component and subassembly manufacturing 1006. As another example, composite forming tool 152 may be used to form a replacement composite part after having received coating 104 from autonomous coating robot 102 during maintenance and service 1014 of FIG. 10.

Apparatuses and methods embodied herein may be employed in manufacturing at least one component of aircraft 1100. For example, a composite structure for one of airframe 1102 or interior 1106 may be formed using composite forming tool 152 with coating 104 applied by autonomous coating robot 102.

The illustrative examples present an autonomous coating robot and methods for operating an autonomous coating robot to apply a coating to a substrate. The illustrative examples reduce labor time and costs for applying coatings to substrates. Additionally, the illustrative examples reduce human exposure to coatings by applying the coatings using an autonomous coating robot.

In some illustrative examples, the autonomous coating robot applies coating to a substrate in less time than an operator applying the coating. By reducing the time of the coating application process to a composite forming tool, the productivity of the composite forming tool is increased. By performing coating application using an autonomous coating robot, the repeatability of applying the coating to a substrate is increased over manual application by an operator.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. An autonomous coating robot comprising:
a housing with a coating supply port configured to mate with an external supply line;
a pair of drive wheels connected to the housing;
a plurality of sensors associated with the housing; and
a sprayer fluidly connected to the coating supply port.

2. The autonomous coating robot of claim 1, wherein the sprayer is configured to disperse a coating onto a portion of a substrate beneath the housing.

3. The autonomous coating robot of claim 2 further comprising:
a mechanical applicator configured to spread the coating across the substrate.

4. The autonomous coating robot of claim 1, wherein the sprayer is configured to disperse a coating onto a portion of a substrate after the housing has passed over the portion of the substrate.

5. The autonomous coating robot of claim 1, wherein the housing is formed of a chemically resistant material configured to protect electronic components of the autonomous coating robot from a coating.

6. The autonomous coating robot of claim 1, wherein the plurality of sensors comprises a plurality of infrared sensors.

7. The autonomous coating robot of claim 1 further comprising an electromagnetic clamping system.

8. The autonomous coating robot of claim 1 further comprising a plurality of unpowered wheels.

9. A method comprising:
supplying a coating to a sprayer of an autonomous coating robot through an external supply line;
spraying the coating onto a surface of a substrate while driving the autonomous coating robot in a first series of parallel connected paths across the surface of the substrate; and
spraying the coating onto the surface of the substrate while driving the autonomous coating robot in a second series of parallel connected paths across the surface of the substrate, wherein the first series of parallel connected paths is perpendicular to the second series of parallel connected paths.

10. The method of claim 9, wherein driving the autonomous coating robot in the first series of parallel connected paths comprises:
driving the autonomous coating robot in a first direction;
spraying the coating onto the surface of the substrate while driving the autonomous coating robot in the first direction;
detecting an edge of the surface of the substrate;
stopping driving and spraying by the autonomous coating robot;
driving the autonomous coating robot in reverse;
turning the autonomous coating robot 90 degrees on the surface of the substrate;
spraying the coating onto the surface of the substrate while driving the autonomous coating robot along a connection;
stopping driving and spraying by the autonomous coating robot;
turning the autonomous coating robot 90 degrees on the surface of the substrate;
driving the autonomous coating robot in a second direction, wherein the first direction is 180 degrees from the second direction; and
spraying the coating onto the surface of the substrate while driving the autonomous coating robot in the second direction.

11. The method of claim 10, wherein a length of the connection is selected based on a width of plume of the sprayer.

12. The method of claim 9, wherein the coating comprises one of a release coating, a paint, or a maskant.

13. The method of claim 9, wherein the substrate is a composite forming tool.

14. The method of claim 9, wherein spraying the coating onto the surface of the substrate while driving the autonomous coating robot in the first series of parallel connected paths across the surface of the substrate forms a first layer of coating on the surface, the method further comprising:
driving the autonomous coating robot across the first layer of coating on the surface of the substrate while driving the autonomous coating robot in the second series of parallel connected paths.

15. The method of claim 9 further comprising:
sensing edges of the surface of the substrate using a plurality of sensors associated with a housing of the autonomous coating robot; and
driving the autonomous coating robot in the first series of parallel connected paths using output of the plurality of sensors.

16. A method comprising:
supplying a coating to an autonomous coating robot through an external supply line connected to a coating supply port in a housing of the autonomous coating robot; and
spraying the coating onto a surface of a substrate using a sprayer of the autonomous coating robot as the autonomous coating robot traverses the surface of the substrate such that the coating covers the surface of the substrate, wherein the sprayer is fluidly connected to the coating supply port, and wherein the autonomous coating robot traverses the surface of the substrate using a pair of drive wheels connected to a housing of the autonomous coating robot.

17. The method of claim 16 further comprising:
driving the autonomous coating robot across the surface of the substrate using the pair of drive wheels, wherein spraying the coating onto the surface of the substrate comprises spraying the coating onto a portion of the surface of the substrate as the autonomous coating robot is driving across the surface of the substrate and after drive wheels of the autonomous coating robot have traversed the portion of the surface.

18. The method of claim 17, wherein spraying the coating onto a surface comprises spraying the coating beneath the housing of the autonomous coating robot.

19. The method of claim 16, wherein spraying the coating onto the surface of the substrate using the sprayer of the autonomous coating robot as the autonomous coating robot traverses the surface of the substrate such that the coating covers the surface of the substrate forms a first layer, the method further comprising:
spraying the coating onto the first layer on the surface of the substrate using a sprayer of the autonomous coating robot as the autonomous coating robot traverses the first layer.

20. The method of claim 16 further comprising:
electromagnetically clamping the autonomous coating robot to the substrate prior to spraying the coating.
